(19) United States
(12) Patent Application Publication
(10) Pub. No.: US 2023/0270285 A1
(43) Pub. Date: Aug. 31, 2023

(54) SYSTEM AND AN APPARATUS FOR PREPARING A FOOD ITEM

(71) Applicant: Vivek KEDIA, Wellington (NZ)

(72) Inventor: Vivek KEDIA, Wellington (NZ)

(21) Appl. No.: 17/912,444

(22) PCT Filed: Mar. 19, 2021
(86) PCT No.: PCT/IN2021/050285

§ 371 Date: Sep. 16, 2022

(30) Foreign Application Priority Data
Mar. 19, 2020 (IN) 202021011984

(51) Int. Cl. A47J 36/32; A47J 27/00

(52) U.S. Cl. CPC A47J 36/32; A47J 27/002

(57) ABSTRACT

An apparatus and a system for automatically preparing a food item with compartments to store ingredients and a controller (218) to maintain the temperature of the compartments is disclosed. The present invention allows a user to be able to have a freshly prepared food item by storing the ingredients at their required temperatures. The user provides an input to the controller (218) to store the ingredients for a predetermined time before preparing the food item. The ingredients are able to preserve their freshness and nutritious value and the users get to eat a fresh food item. The present invention comprises a storage unit (214, 216) for downloading and uploading e-recipes and a communication unit (208) for connecting the controller (218) and user device (301) to give instructions to the controller (218).

### FIELD OF INVENTION

The present invention relates to a system and an apparatus for preparing a food item and more particularly relates to the system and the apparatus for preparing the food item that may store the ingredients at required temperatures.

### BACKGROUND

Preparing a food item not only involves actually cooking the food, but also deciding what to cook, and knowing how to cook it. It also requires planning, learning the recipe, buying the ingredients, and then preparing it. To prepare a fresh food item, a person must cook at the same time they want to eat. If the food is cooked at an earlier time, it gets stale and loses its nutritious value. Even reheating an already cooked food can turn healthy food to harmful one. Reheating food can not only destroy the nutrients in the food but also cause food poisoning and food-borne diseases. An alternative is to prepare the ingredients beforehand and keeping them aside; and then prepare fresh food item at a later time. However, such ingredients also tend to lose their nutrients and freshness, when not stored properly. In order to provide a healthy meal, it is important that food is prepared fresh at any given time, which in turns makes it important that the ingredients to be used are also fresh.

Even when the ingredients are ready, preparing or cooking a meal still consumes time and a person, in some scenarios, who returns home after a long day and desires to have fresh food, can have it only after cooking it which may take longer time and the person is forced to endure hunger.

Therefore, there is a need for a device that can prepare a food item automatically at user's convenience and also capable of storing raw ingredients at a temperature such that their freshness and nutrition value remains intact.

### SUMMARY

The following summary is provided to facilitate an understanding of some of the innovative features unique to the disclosed embodiment and is not intended to be a full description. A full appreciation of the various aspects of the embodiments disclosed herein can be gained by taking into consideration the entire specification, claims, drawings, and abstract as a whole.

The present invention relates generally to automatic food preparation. Embodiments of the disclosure are related to an apparatus and a system of food preparation comprising one or more compartments for storing ingredients required to prepare a food item and a controller that maintains the temperature of the ingredient storage compartments based on the user input.

The present invention is advantageous in several ways, including, but not limited to, providing a method to automatically prepare a fresh food item with temperature controlled storage. The apparatus which is an automatic meal maker includes a container, an agitator for mixing and stirring, and different compartments for each ingredient a recipe might require, which can be set at different temperatures based on the amount of time they need to be stored in the device. The storage of ingredients at different temperatures provide the benefit of a longer life and preserving the freshness of ingredients without losing their nutritious value. The apparatus prepares a variety of food items from different cuisines. A user can download any recipe they want from the interne or upload their own customized recipe or share the recipes with other users. This provides a huge cost saving benefit to restaurants as it cooks for multiple people and at the same time, reduces the need of hiring many people to cook. The user will know the exact time a food item takes to be prepared. It is also useful for people who want homemade food but do not have the time or the skill to cook themselves. It provides users with fresh food every time with an additional feature of a time delay setting wherein the user can set any time to start preparing the food item. Moreover, the apparatus ensures the perfect taste every time unlike a manually cooked food item. From the quantity of ingredients and spices to temperature and time settings, the apparatus takes care of everything while preparing a food item.

It is therefore, one aim of the disclosed embodiments, to provide an apparatus and a system configured to set and maintain a certain temperature for storing different ingredients. Embodiments of the present invention provide a solution of preserving the nutritious value of the ingredients even if stored for a long time and preventing them from going stale.

In a first aspect of the present invention, an apparatus for preparing a food item is disclosed. The apparatus comprises one or more compartments for receiving and storing ingredients and a controller that receives an input from a user to store ingredients at particular temperature for a particular duration of time or maintains the temperature until instructed by the user.

According to an embodiment to the first aspect of the present invention, the controller is configured to operate the one or more compartments in cold storage mode or food item preparation mode.

According to an embodiment to the first aspect of the present invention, the food item is prepared in a container receiving ingredients from the compartments and the container is kept in contact of a heating element. The container is attached to an agitator to mix or stir the ingredients.

According to an embodiment of the first aspect of the present invention, the one or more compartments are covered by a lid.

According to an embodiment to the first aspect of the present invention, the controller is coupled with a temperature sensor for sensing the temperature of the container.

According to an embodiment to the first aspect of the present invention, the controller is coupled with a microphone to receive voice input from the user and coupled with a speaker for an audio output.

In a second aspect of the present invention, a system for preparing a food item is disclosed. The system comprises one or more compartments for ingredients, a controller that receives an input from a user to store ingredients at particular temperature for a particular duration of time or maintains the temperature until instructed by the user and a storage unit for storing one or more e-recipes.

According to an embodiment to the second aspect of the present invention, the controller is communicatively coupled with a user device for receiving input from the user.

According to an embodiment to the second aspect of the present invention, the storage unit is a local storage or a cloud storage.

According to an embodiment to the second aspect of the present invention, the e-recipes are shared with other users over cloud storage.

According to an embodiment to the first second of the present invention, the e-recipes are customizable.

According to an embodiment to the second aspect of the present invention, the customized e-recipes are at least one of an audio file, text file, or video file.

According to an embodiment to the second aspect of the present invention, the controller is coupled with the user device through wired or wireless communication.

According to an embodiment to the second aspect of the present invention, the controller is configured to download or upload e-recipes.

According to an embodiment to the second aspect of the present invention, the controller is configured to operate one or more compartments in cold storage mode.

### BRIEF DESCRIPTION OF DRAWINGS

FIG. 1 discloses an exemplary embodiment of the present invention and depicts a top perspective view of apparatus 100.

FIG. 2 discloses an exemplary embodiment of the present invention and depicts a side perspective view of the apparatus 100.

FIG. 3 discloses an exemplary embodiment of the present invention and depicts a front perspective view of the apparatus 100.

FIG. 4 discloses an exemplary embodiment of the present invention and depicts a top view of the ingredients compartments 110-117 in the apparatus.

FIG. 5 discloses an exemplary embodiment of the present invention and depicts a top perspective view of the apparatus 100 with the lid 108.

FIG. 6 discloses an exemplary embodiment of the present invention and depicts a front perspective view of the apparatus 100 with the lid 108.

FIG. 7 discloses an exemplary embodiment of the present invention and depicts a side perspective view of the apparatus 100 with lid 108.

FIG. 8 discloses an exemplary embodiment of the present invention and depicts a perspective view of the spices compartments 120-127 in the apparatus 100.

FIG. 9 discloses an exemplary embodiment of the present invention and depicts the system 200 of the apparatus 100.

FIG. 10 discloses an exemplary embodiment of the present invention and depicts the sharing of recipes over cloud storage 216 in the system 200.

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale. Wherever possible, like elements have been indicated by identical numbers.

REFERENCE NUMERALS

| Reference Numerals | Description of Element |
|---|---|
| Apparatus | 100 |
| Tray | 102 |
| Container | 104 |
| Heating Element | 106 |
| Lid | 108 |
| First set of compartments for ingredients | 110-117 |
| Second set of compartments for spices | 120-127 |
| Motor | 118, 128 |
| System | 200 |
| Microphone | 202 |
| Speaker | 204 |
| Display unit | 206 |
| Communication unit | 208 |
| Temperature Sensor | 210 |
| Temperature Adjustor | 212 |
| Local Storage | 214 |
| Cloud Storage | 216 |
| User Devices | 301, 302, 303 |

### DETAILED DESCRIPTION

The particular configurations discussed in the following description are non-limiting examples that can be varied and are cited merely to illustrate at least one embodiment and are not intended to limit the scope thereof.

The present invention discloses a system and an apparatus for preparing a food item, for example, an automatic meal maker that stores ingredients at a required temperature for preparing a food item at a later time. The disclosure may include a temperature sensor and a temperature adjustor to control the temperature at which ingredients are stored. The disclosure may include a container and a heating element for preparing a food item. The disclosure may also include different compartments for putting in required ingredients for a food item which may be chosen by the user by downloading the recipe from the internet or uploading their own customized recipe. The disclosure may also include a display for selecting a recipe or watching a video of a recipe with a speaker for listening to the instructions of the video. The present invention combines the features of a dough kneader, bread maker, popcorn maker, rice cooker, slow fryer, etc.

Various non-limiting benefits of the present disclosure include preparing a fresh food item by storing ingredients at a required temperature, informing the user the exact time a food item takes to cook, from mixing and stirring to setting a required temperature to adding different ingredients at different times, downloading any recipe from the internet or uploading a customized recipe and sharing it with others, preparing a variety of food items from different cuisines, cooking for multiple people, and setting any time for the cooking to start.

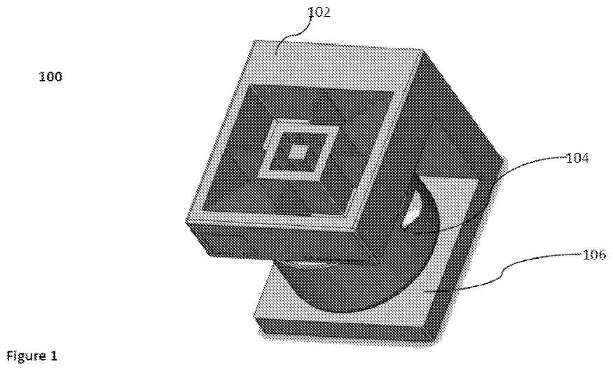

FIG. 1 shows an apparatus which may be an automatic meal maker 100. The apparatus 100 may include a container 104 and a heating element 106. The apparatus 100 may be made of materials like steel, aluminium, etc. The apparatus 100 may have a fan for ventilation purpose while cooking. The apparatus 100 may have a safety sensor and a stop button in case of an emergency. The container 104 may be a cooking pot or a cooking pan. The container 104 may have a lid to open close as required by the recipe. The container 104 may have a steamer for the vapour to have an outlet while cooking. The container 104 may have one or more handles for a user to pick it up and place it back. The container 104 may be kept in contact of the heating element 106 which will provide required heat for preparing a food item. The heating element 106 may be gas powered or electricity powered providing direct or induction heat to the container 104 that may be controlled to increase or decrease the heat depending upon the recipe. The container 104 may include an agitator for chopping, stirring and mixing the ingredients at different intervals as required by the recipe.

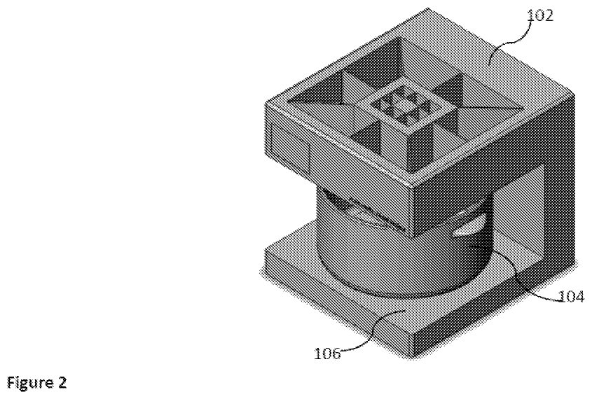

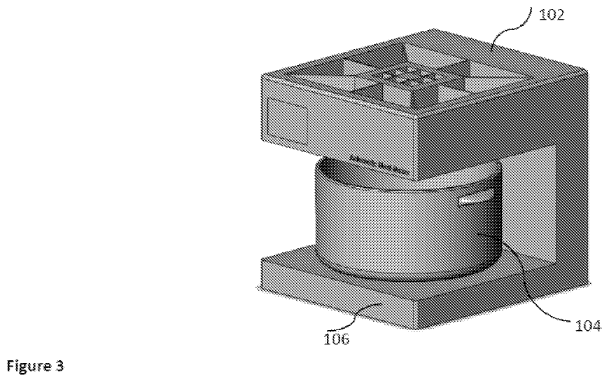

FIGS. 2 and 3 disclose an exemplary embodiment of the present invention and depict two different perspectives of the apparatus 100 comprising the container 104 and the heating element 106.

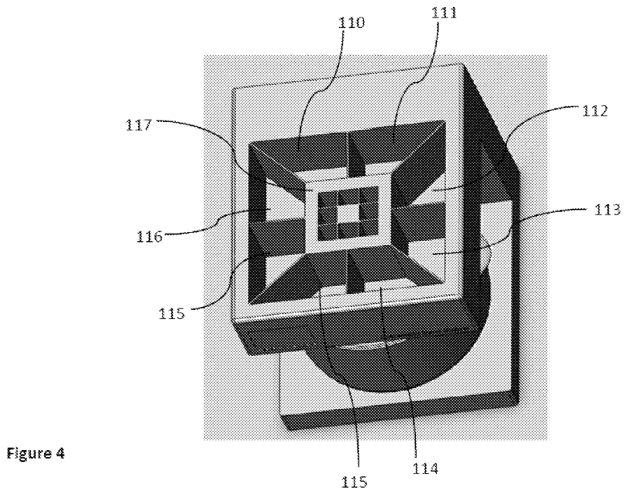

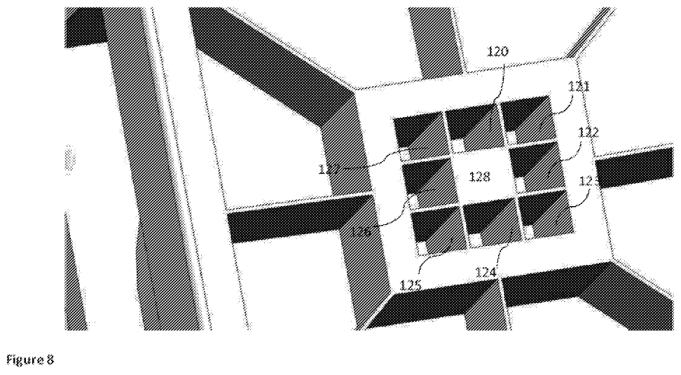

The apparatus 100 may include a tray 102 with compartments for ingredients and spices. FIG. 4 shows the tray 102 with compartments for storing ingredients 110-117 and FIG. 8 shows the compartments for storing spices 120-127. The tray may have a shifting base dispensing each ingredient into the container 104 as and when required according to the recipe. The apparatus 100 may have a sensor with a predefined code to identify the ingredients and spices. The ingredients may be stored in two different modes, a cold storage mode for preserving the freshness and a food item preparation mode for when the apparatus 100 starts preparing the food item. The ingredients may be measured with a measuring cup and dispensed into the container 104. The base of the tray 102 may rotate as and when an ingredient is required in the recipe and dispense it into the container 104. The tray 102 may include a first motor 118 for rotating the ingredients when required in the recipe and a second motor 128 for rotating the spices when required by the recipe. The motor 118, 128 may move the tray 102 and the tray 102 may dispense the required ingredient or spice.

The user may put any number of raw ingredients and spices that may be used while preparing a food item and the apparatus 100 prepares the food item itself by following a recipe. Ingredients may include vegetables, rice, noodles, etc. and spices may include powders, liquids, sauces, seasonings etc. For example, if the user wants to make noodles, they may fill the container 104 with water, the ingredient compartments 110-117 with noodles and vegetables, and the spices compartments 120-127 with salt and noodle powder. When the water boils to the right temperature, the tray 102 of apparatus 100 may dispense noodles from one of the compartments into the container. At a different time, the tray 102 may dispense vegetables from the compartment and finally, salt and noodle powder from the spices compartments. The agitator in the container 104 may stir and mix all the ingredients together as required by the recipe and the noodles will be ready without any human intervention.

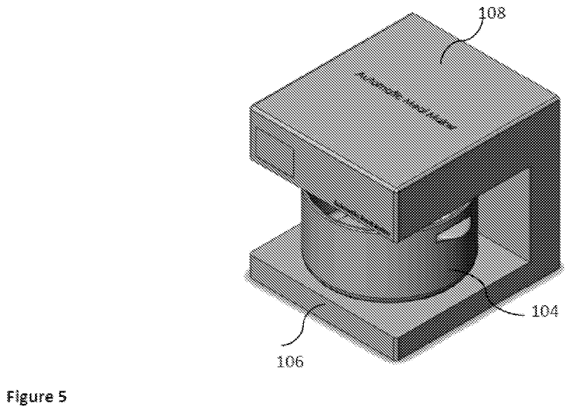

FIG. 5 shows the apparatus 100 wherein the tray 102 may also have a lid 108 to cover the compartments. The lid 108 may cover and prevent the ingredients from falling off the tray 150. The lid 108 may be removable such that the tray 102 may be refilled if any compartment may be empty or may need more quantity of an ingredient or a spice. The lid 108 may also keep the ingredients and spices clean, prevent them from dust and increase their storage life.

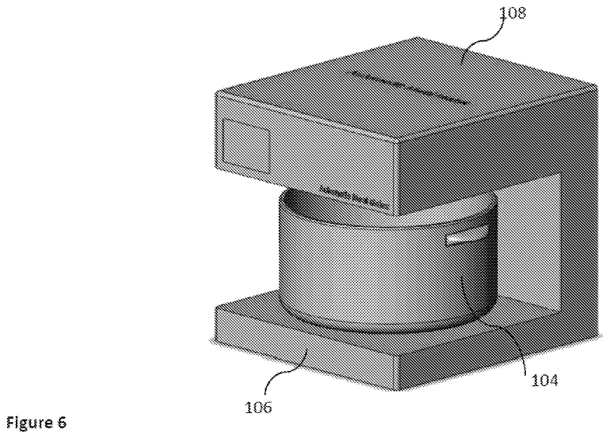

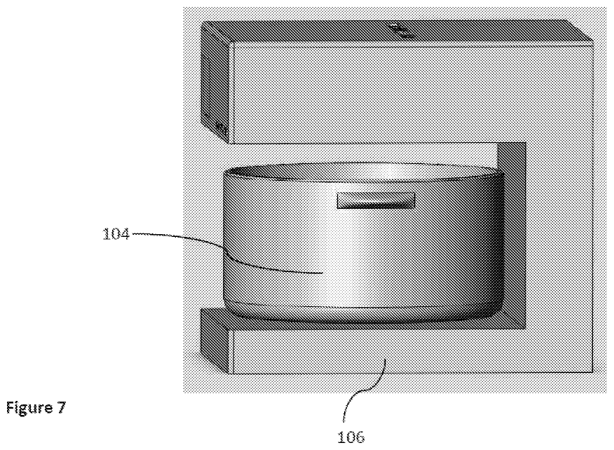

FIGS. 6 and 7 disclose an exemplary embodiment of the present invention and depict different perspective views of the apparatus 100 comprising the container 104, the heating element 106, and the lid 108 over the compartment tray 102.

The apparatus 100 may also include a storage compartment for oil or water connected to the container 104. The storage compartment may dispense water or oil into the container 104 when required by the recipe.

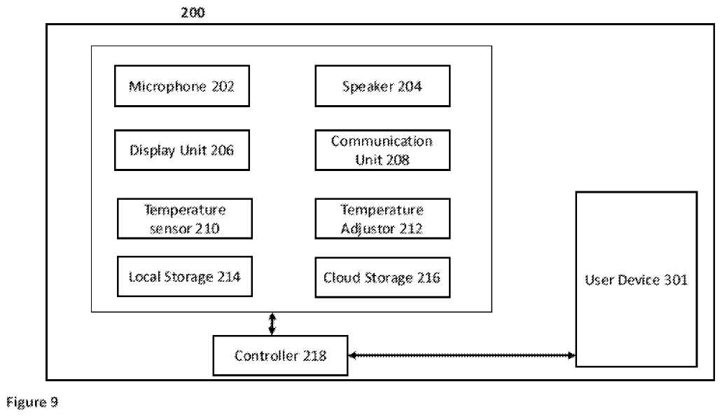

Another embodiment of the invention shows the system 200 of the apparatus 100 as shown in FIG. 9. The system 200 may include a microphone 202, a speaker 204, a display unit 206, a communication unit 208, a temperature sensor 210, a temperature adjustor 212, a local storage 214 and a cloud storage 216. A controller 218 may be connected to the system 200 and a user device 301.

The controller 218 may have the features of setting a time delay for the apparatus 100 to start cooking. For example, the user may put in all ingredients and spices in the apparatus 100 and may set a time in the morning that the food item should be prepared by evening at 6 p.m. The user may also choose any recipe in the apparatus 100 through the user device 301, for example, mobile, tablet, etc., connected to the Internet from a remote place and give command to the controller 218 to start preparing.

The apparatus 100 may not require internet services for the operation of preparing the food item.

In one embodiment, the apparatus 100 may be connected to the user device 301 through Bluetooth for a short distance command to be given by the user.

In another embodiment, the apparatus 100 may use different technologies, for example, NFC (Near Field Communications), BLE (Bluetooth Low Energy), etc. Most operating systems, for example, Android, iOS, and Windows support at least one of these technologies. The user may select a recipe and may send it to the controller 218 using any one of these technologies.

The list of the recipes that the user accesses may be divided based on cuisine, time taken to prepare, vegetarian, non-vegetarian, sweets, snacks, breakfast, and more. The list may help the user decide on a recipe as per their needs. The recipes may be free or paid. The paid recipe can be bought or rented.

The system may give commands to the apparatus 100 according to the recipe. For example, the controller 218 may detect the current temperature and may give commands to the heating element 106 for container 104 and to the temperature adjustor 212 for compartments as to increase or decrease the temperature such that the ingredients may be stored and the food item may be prepared without getting burned or spoiled respectively. The agitator may be instructed by the system 200 when to chop, stir or mix the ingredients in the container 104. The system 200 may give commands to the motor 118, 128 when to dispense an ingredient or a spice and how much quantity may be dispensed. A user uploading their own recipe may set their own instructions, for example, time of dispensing an ingredient, quantity of an ingredient, temperature of preparing, etc. The user may also choose the quantity of the food item according to the number of people.

The communication unit 208 may connect the controller 218 and the user device 301. The communication unit 208 may be used when the user device 301 gives any instruction to the system 200 for example, storing ingredients at a particular temperature, a remote instruction to start preparing a food item, setting a time for preparing the food item, etc.

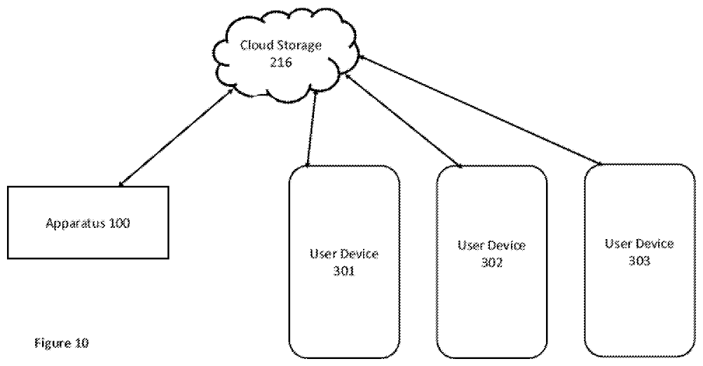

The system 200 may be connected to the internet and may download any recipe to make. The downloaded recipe may be stored locally 214 or over a cloud 216. In addition, the user may also be able to upload their own customized recipe or share a recipe from the user device with other users 301, 302, 303 over the cloud 216 as shown in FIG. 10. The downloaded or uploaded recipes may be saved for future use. The recipes may be shown on the display unit 206. The display screen may be square or rectangular in shape and may either be black and white or a colour screen. The display unit 206 may show texts, images, videos, etc. For example, the step by step guide of a recipe or the video of a recipe may be seen on the display 206. The display 206 may allow a user to select which recipe to make and the system 200 may give commands to start preparing the food item. The current temperature and the time delay setting (if any) may also be visible on the display unit 206. The display unit 206 may also provide notifications about the preparing food item, for example, how much time is left.

The microphone 202 may be used to provide voice instructions by the user to the controller 218. The user may give commands of adding an ingredient or spice, increasing or decreasing the heat, choosing a recipe, etc. through the microphone 202.

The temperature sensor 210 in the system 200 may control the temperature by increasing or decreasing the heat in the container 104 when preparing a food item as different ingredients or food items may require different temperatures to prepare. The temperature sensor 210 may also provide for storing certain ingredients in the compartments tray 102 at a required temperature as to preserve their freshness and prevent them from going stale. The controller 218 may receive the current temperature from the temperature sensor 210 and give command to the temperature adjustor 212 to maintain a certain temperature based on the input received by the user.

The speaker 204 may be used by the user when watching a video of a recipe on the display unit 206, for example, each step of the recipe is explained through speaker output. The speaker 204 may also be used whenever there is a notification alert on the display unit 206, for example, when the food item preparation starts, how much time is left, when the food item is ready, etc. The notification alert may be a sound or a voice.

I claim:

1. An apparatus (100) for preparing a food item, the apparatus comprising:
one or more compartments for receiving ingredients required for preparing the food item; and
a controller (218) configured to control the temperature of at least one of the one or more compartments based on an input received from a user,
wherein the controller continues to maintain the temperature of at least one of the one or more compartments until an instruction is received from the user for preparing the food item.

2. The apparatus as claimed in claim 1, wherein the controller (218) is configured to operate the one or more compartments in at least one of a cold storage mode and a food item preparation mode.

3. The apparatus as claimed in claim 1, wherein the food item is prepared in a container (104) configured to receive the ingredients from the one or more compartments, wherein the container is kept in contact of a heating element (106) for preparing the food item, and wherein the container (104) has an attached agitator to mix or stir the ingredients.

4. The apparatus as claimed in claim 1, wherein the one or more compartments are covered by a lid (108).

5. The apparatus as claimed in claim 3, wherein the controller is coupled with a temperature sensor (210) for sensing the temperature of the container (104).

6. The apparatus as claimed in claim 1, wherein the controller (218) is coupled with a microphone (202) for receiving voice input from the user, and
wherein the controller (218) is coupled with a speaker (204) for an audio output.

7. A system for preparing a food item, the system comprising:
one or more compartments for receiving ingredients required for preparing a food item:
a controller (218) configured to control the temperature of at least one of the one or more compartments based on an input received from a user,
wherein the controller (218) continues to maintain the temperature of at least one of the one or more compartments until an instruction is received from the user for preparing the food item; and
a storage unit for storing one or more e-recipes for preparing the food item.

8. The system as claimed in claim 7, wherein the controller (218) is communicatively coupled with a user device (301) for receiving the input from the user.

9. The system as claimed in claim 7, wherein the storage unit is at least one of a local storage (214) and a cloud storage (216).

10. The system as claimed in claim 9, wherein the e-recipe is shared with other users over cloud storage (216).

11. The system as claimed in claim 10, wherein the e-recipe is customizable.

12. The system as claimed in claim 11, wherein the customized e-recipe is at least any one of an audio file, text file, a video file.

13. The system as claimed in claim 8, wherein the controller (218) is coupled with the user device (301) through wired or wireless communication means.

14. The system as claimed in claim 13, wherein the controller (218) is configured to upload or download one or more e-recipes.

15. The system as claimed in claim 14, wherein the controller is configured to operate the one or more compartments in cold storage mode.

16. The system as claimed in claim 7, wherein the controller is configured to operate the one or more compartments in at least one of a cold storage mode and a food item preparation mode.

17. The system as claimed in claim 7, wherein the food item is prepared in a container (104) configured to receive the ingredients from the one or more compartments,
wherein the container (104) is kept in contact of a heating element (106) for preparing the food item, and wherein the container (104) has an attached agitator to mix or stir the ingredients.

18. The system as claimed in claim 7, wherein the one or more compartments are covered by a lid (108).

19. The system as claimed in claim 17, wherein the controller (218) is coupled with a temperature sensor (210) for sensing the temperature of the container.

20. The system as claimed in claim 1, wherein the controller (218) is coupled with a microphone (202) for receiving voice input from the user, and
wherein the controller (218) is coupled with a speaker (204) for an audio output.
